(19) United States
(12) Patent Application Publication
(10) Pub. No.: US 2025/0094225 A1
(43) Pub. Date: Mar. 20, 2025

(54) DYNAMICALLY GENERATING INSTANCE TYPES

(71) Applicant: International Business Machines Corporation, Armonk, NY (US)

(72) Inventors: Abhishek Malvankar, White Plains, NY (US); Alaa S. Youssef, Valhalla, NY (US); Mustafa Eyceoz, Nashua, NH (US); Selbi Nuryyeva, Huntersville, NC (US)

(21) Appl. No.: 18/467,759

(22) Filed: Sep. 15, 2023

(51) Int. Cl. G06F 9/50

(52) U.S. Cl. CPC G06F 9/5027

(57) ABSTRACT

Computer-implemented methods for dynamically generating instance types are presented. Aspects include receiving, by a controller, a user input describing a desired workload and a user intent for the desired workload. Aspects also include generating, by a machine learning model executing on the controller, an entity vector based the user input. Aspects also include accessing, by the controller, an instance type knowledge base comprising vector representations of one or more instance types. Aspects also include calculating, by the controller, a ranking between the entity vector and the vector representations of the one or more instance types in the instance type knowledge base. Aspects further include determining a set of instance types for the desired workload based on the ranking.

### BACKGROUND

The present disclosure relates generally to cloud computing, and more specifically, to a method and system for dynamically generating instance types.

Matching workloads to instance types is a fundamental aspect of optimizing computing resources, especially in cloud environments. This matching process ensures that the computational tasks are run on the most suitable hardware, maximizing efficiency, performance, and cost-effectiveness. Every computational task or application has its own set of requirements. Some may be CPU-intensive, others might require substantial memory, while some may be specifically designed to benefit from GPU acceleration.

Cloud providers offer a wide range of instance types, each optimized for different functions. For instance, some are optimized for high computational power, some for memory, and others for GPU-based tasks. Each instance type comes with a specific combination of CPU, GPU, memory, storage, and network capabilities. While it might be tempting to opt for the most powerful instance type, it might not always be the most cost-effective choice. Users often have to balance between the performance they desire and the cost they are willing to incur.

Some workloads are designed to scale out, meaning they distribute the task across multiple smaller instances, while others scale up, preferring fewer but more powerful instances. The choice of instance type can influence the workload's scalability. Workloads might have varying requirements at different stages. For example, a data analysis task might initially require a memory-optimized instance for data processing but later need a compute-optimized instance for complex calculations.

Some software might be optimized for specific hardware or might have minimum hardware requirements. When selecting an instance type, benefits are realized when ensuring compatibility. Cloud providers continuously update their offerings, introducing new instance types with better performance, often at reduced costs. Matching workloads to the right instance types requires a deep understanding of the workload's requirements, knowledge of available instance types, and often involves a bit of trial and error. The goal is to achieve the best performance while maintaining cost efficiency and ensuring future scalability.

### SUMMARY

Embodiments of the present invention are directed to a computer-implemented method for dynamically generating instance types. According to an aspect, a computer-implemented method includes receiving, by a controller, a user input describing a desired workload and a user intent for the desired workload. The method also includes generating, by a machine learning model executing on the controller, an entity vector based the user input. The method also includes accessing, by the controller, an instance type knowledge base comprising vector representations of one or more instance types. The method also includes calculating, by the controller, a ranking between the entity vector and the vector representations of the one or more instance types in the instance type knowledge base. The method further includes determining a set of instance types for the desired workload based on the ranking.

In one or more embodiments of the present invention, the method also includes selecting, by the controller, a first instance type from the set of instance types for the desired workload.

In one or more embodiments of the present invention, the method also monitoring, by the controller, the desired workload running on the first instance type, generating additional entity vectors based on the monitoring the desired workload running on the first instance type, and re-training the machine learning model using an updated entity vector, wherein updated entity vector comprises the additional entity vector and the entity vector.

In one or more embodiments of the present invention, the user input comprises a YAML file.

In one or more embodiments of the present invention, the YAML file comprises a user intent.

In one or more embodiments of the present invention, the user intent is determined based on a top-level comment in the YAML file.

In one or more embodiments of the present invention, the machine learning model comprises a Bidirectional Encoder Representations from Transformers model.

According to another non-limiting embodiment of the invention, a system having a memory having computer readable instructions and one or more processors for executing the computer readable instructions, the computer readable instructions controlling the one or more processors to perform operations. The operations include receiving, by the processor, a user input describing a desired workload and a user intent for the desired workload. The operations also include generating, by a machine learning model executing on the processor, an entity vector based the user input. The operations also include accessing, by the processor, an instance type knowledge base comprising vector representations of one or more instance types. The operations also include calculating, by the processor, a ranking between the entity vector and the vector representations of the one or more instance types in the instance type knowledge base. The operations further include determining a set of instance types for the desired workload based on the ranking.

According to another non-limiting embodiment of the invention, a computer program product for dynamically generating instance types is provided. The computer program product includes a computer-readable storage medium having program instructions embodied therewith, the program instructions executable by a processor to cause the processor to perform operations. The operations include receiving, by the processor, a user input describing a desired workload and a user intent for the desired workload. The operations also include generating, by a machine learning model executing on the processor, an entity vector based the user input. The operations also include accessing, by the processor, an instance type knowledge base comprising vector representations of one or more instance types. The operations also include calculating, by the processor, a ranking between the entity vector and the vector representations of the one or more instance types in the instance type knowledge base. The operations further include determining a set of instance types for the desired workload based on the ranking.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of a system for dynamically generating instance types according to one or more embodiments of the present invention;

FIG. 3 depicts an example YAML file with entity extraction according to one or more embodiments of the invention; and

FIG. 4 illustrates a block diagram of a method for dynamically generating instance types according to one or more embodiments.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

AI workloads often operate under unique constraints, necessitating that all nodes in the framework cluster be consistently engaged in computation to ensure optimal progress. To address the all-or-none computational requirement characteristic of AI tasks, the selection of nodes to be added to the cluster hinges on specific user-defined resource requirements.

With numerous instance types available, cloud providers offer a plethora of options, each with its distinct computational capabilities, such as GPU count and GPU memory. For instance, the P3.2xlarge from one provider offers an equivalent CPU count and GPU memory as the g4dn.xlarge from another. However, simply matching hardware specifications is insufficient to determine the optimal instance type for a workload. A more nuanced understanding of the workload's intricacies is crucial.

Further complicating the selection process, cloud providers frequently introduce new instance types tailored to cater to the evolving demands of user workloads. They often employ divergent terminologies when categorizing these instances, which makes directly translating user resource requirements—like CPU, GPU, and memory—to an appropriate instance type challenging.

Take the ‘ray’ workload as an example: its diverse resource needs mean a CPU instance might be apt for its head node, while GPU instances would better suit its N worker nodes. An ill-informed choice in instance type could either result in significant computational inefficiencies or lead to resource over-provisioning.

Moreover, the optimal instance type for a workload might differ based on the workload's phase, be it training or inference. Thus, there's a pressing need to ascertain the exact instance type a workload necessitates, considering these varied factors.

Disclosed herein are methods, systems, and computer program products that can dynamically incorporate the desired instances into a cluster, reflecting the specific and potentially fluctuating resource requirements of users. This further includes a learning system capable of discerning the correlations between distinct user-specified workload sections and suitable instance types.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as system identification and connectivity creation (block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

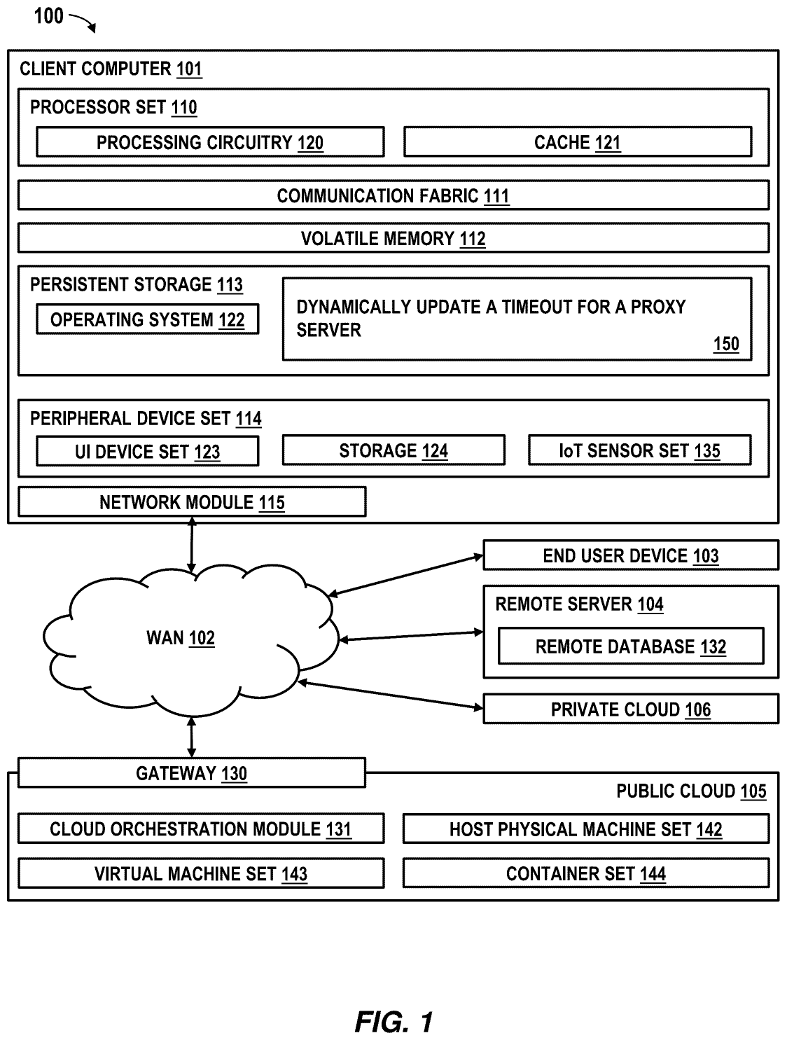

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Determining the appropriate instance type for running a particular workload is key for managing workloads for several reasons. Different workloads have different resource requirements. Selecting the best instance type ensures that there is no over-provisioning (wasting resources) or under-provisioning (leading to poor performance). Further, the cost of cloud resources can add up quickly. By selecting a highly suitable instance type, benefits include cost optimization, ensuring the user only pays for what is needed. Additionally, some workloads might require high computational power, while others may need better memory or storage capabilities. The right instance type can provide the optimal balance of CPU, memory, and other resources to ensure good performance. Some workloads, like machine learning training or video processing, may require specialized hardware such as GPUs. Certain instance types are optimized for these kinds of tasks. As applications grow, scaling of resources may be required. Some instance types are better suited for horizontal scaling, while others are optimized for vertical scaling. Workloads that handle sensitive data may have specific compliance requirements that are only met by particular types of instances. If your workload needs to transfer large amounts of data quickly, they will need an instance type that offers high network bandwidth.

For real-time processing workloads, low latency is critical. Some instance types are optimized to offer lower latency. Depending on the criticality of the application, instance type that offers high availability and fault tolerance may be needed. If working with multiple cloud providers, an instance type that offers the most seamless integration between them may be required. In some cases, energy efficiency of the instance types as part of a broader sustainability strategy may be a consideration. Determining the right instance type is not just a matter of picking any available option; it involves a consideration of various factors that influence the performance, cost, and success of a workload. Doing this effectively can result in benefits both operationally and financially.

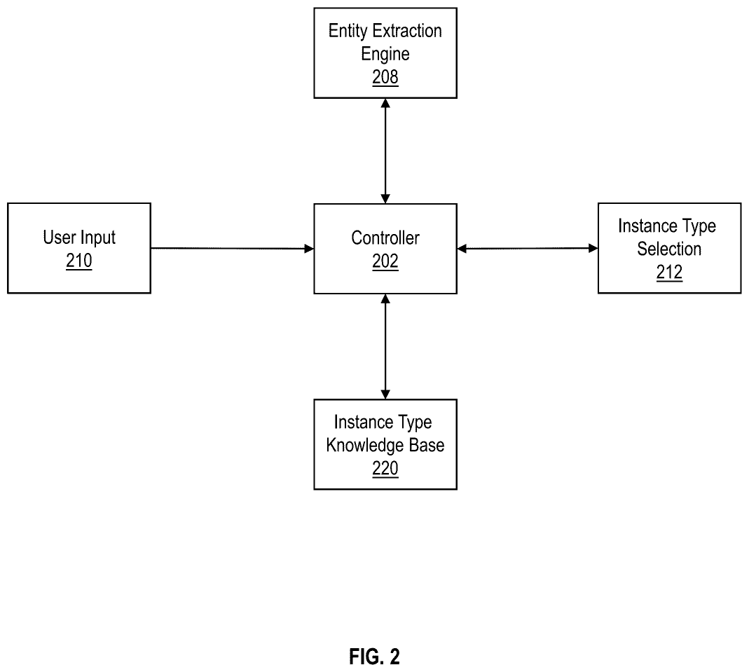

Referring now to FIG. 2, a block diagram of a system 200 for dynamically generating instance types is generally shown in accordance with one or more embodiments of the present invention. The system 200 includes a controller 202 that can receive a user input 210, typically, in the form of a YAML file that includes a user intent. The YAML file includes a description of a desired workload for the controller 202 to select an instance type to match the desired workload and user intent. The YAML file from the user input 210 is parsed by the controller 202 using an entity extraction engine 208 to generate entity vectors.

The controller 202 utilizes a machine learning model to analyze the vectors extracted from the YAML file. The machine learning model has been previously trained using embeddings and can assist with determining proper workload instance types by correlated the vectors with an instance type knowledge base 220. The machine learning model can be any type of learning model. In one or more embodiments, the controller 202 selects a set of top-K instance types from the instance type knowledge base 220 based on the YAML file, including the user intent. In this scenario, “K” is a pre-determined integer representing the number of instance types to be recommended. The user intent can specify, for example, desired characteristics of the instance type including instances with a high density of GPUs, instances with high bandwidth, and instances with the lowest costs, among other desired characteristics.

In one or more embodiments, the user input 210 is in the form of a YAML file. The YAML file (which stands for “YAML Ain′t Markup Language”) is a human-readable data serialization format. It can be used for configuration files and data exchange between languages with different data structures. YAML files are designed to be easy to read and write for humans while remaining machine-readable. In the context of YAML files, “user intent” usually refers to the specifications or configurations a user declares to dictate how a particular service or application should behave. In a YAML file, users can set various parameters, resource limits, policies, and other settings to articulate their specific requirements or desired state for the system.

For example, in a YAML file, a user may specify a desire to deploy three replicas of a particular container, limit the CPU and memory resources available to it, expose certain ports, mount particular storage volumes, and so on. The “user intent” is to have a high-availability service with specific resource constraints. The “user intent” captures the desired configuration and behavior the user desires for a given workload.

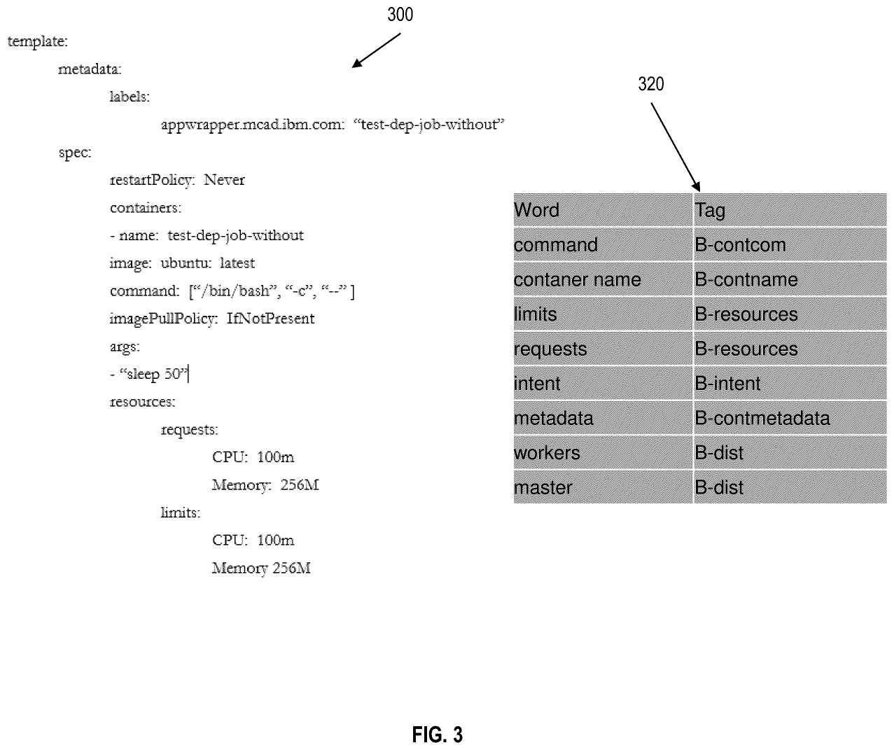

FIG. 3 depicts an example YAML file with entity extraction according to one or more embodiments of the invention. The sample YAML file 300 includes descriptions like container name, container command, container resources, application metadata, framework name. The user intent is a new field inside the user YAML file 300. In this example, user intent specifies requests and limits for CPU and Memory in addition to a description of containers, and like. The controller 202 (from FIG. 2) extracts a dataset 320 for each field in the YAML file 300. In addition, the controller 202 (from FIG. 2) can derive a user intent through analysis of the YAML file and sections and descriptions contained therein. In this example, the YAML file 300 shows a user intent to have an instance type that can be a fast responding instance type for the workload described. The dataset 320 is converted to vectors by the controller 202 for the machine learning model to determine top-K instance types for the desired workload. A suggested instance type is selected from the top-K instancy types either through a user input from the user or by the controller 202.

In one or more embodiments, the user intent from the YAML file can be derived from extraction as described above. Further, semantic information can be obtained from the YAML file through a top-level comment in the form of a string. A “top-level comment” refers to a comment that is not indented and appears at the start of a line. Comments in YAML start with the ‘#’ character, and anything following this character on the same line is considered a comment and is ignored by the YAML parser. For example, top-level comments can be expressed in terms of time constraints, cost limits or concerns, tensor core requirements, carbon footprint limits or concerns, power constraints, and/or additional English language context for a workload. The controller 202 (from FIG. 2) can parse the top-level comments in a YAML file and extract additional entities for the entity vector. The parsing can be performed using natural language processing and/or other machine learning engines for deriving meaning from natural language.

In one or more embodiments, the model to convert the user input YAML file is the BERT model that can convert different sections of the file into vectors. The BERT model, which stands for Bidirectional Encoder Representations from Transformers, is a pre-trained deep learning model primarily used for natural language processing (NLP) tasks. Table 1 depicts a sample features using the BERT model:

TABLE 1
Sample features of dataset

| Container | Workload | | | | ephemeral | |
|---|---|---|---|---|---|---|
| Name | Name | CPU | GPU | Memory | storage | User Intent |
| asm582/ | Codeflare- | 8 | 8 | 32 GB | 64 GB | Low Cost |
| bert | bert- | | | | | |
| | fine-tuning | | | | | |
| fms/ | Codeflare- | 8 | 64 | 16 GB | 64 GB | Dense |
| GLUE | bert- | | | | | machine- |
| | pre-training | | | | | high # of |
| | | | | | | GPUs |

In one or more embodiments of the invention, the features from Table 1 can be utilized to develop entity and/or feature vectors to be utilizes by the controller 202 to select instance types of the desired workload. Instance types can be selected from across cloud-computing platforms.

In one or more embodiments of the invention, the controller 202 identifies and can select an instance type for the desired workload from the set of top-K instance types. Once selected and the workload is running on said instance type, the controller 202 continues to monitor the performance, progress, and/or status of the workload on the selected instance type.

In one or more embodiments of the invention, the controller 202 can monitor the selected instance type for the user specified workload and continue to collect data. The data is parsed and vectorized for re-training of the machine learning model. The vectors derived from the monitoring can be merged with the original vector derived from the user input and then used to re-train the machine learning model by the controller 202. The new merged vector can be stored in the instance type knowledge base 220.

In one or more embodiments of the invention, when determining an instance type, the system 200 can begin by assessing the available resources within the cluster. It then determines the additional or ‘delta’ resources needed, specifically for comparable workloads. When suggesting aggregate instance types, the system employs embedding, as outlined previously. From the total aggregate resource types required, the system cross-references to identify if similar free instances already exist within its current infrastructure. If the desired instance types are freely available within the system, it will only procure the ‘delta’ instances from the cloud provider. This approach not only promotes the efficient reuse of instances but also facilitates quicker workload startups.

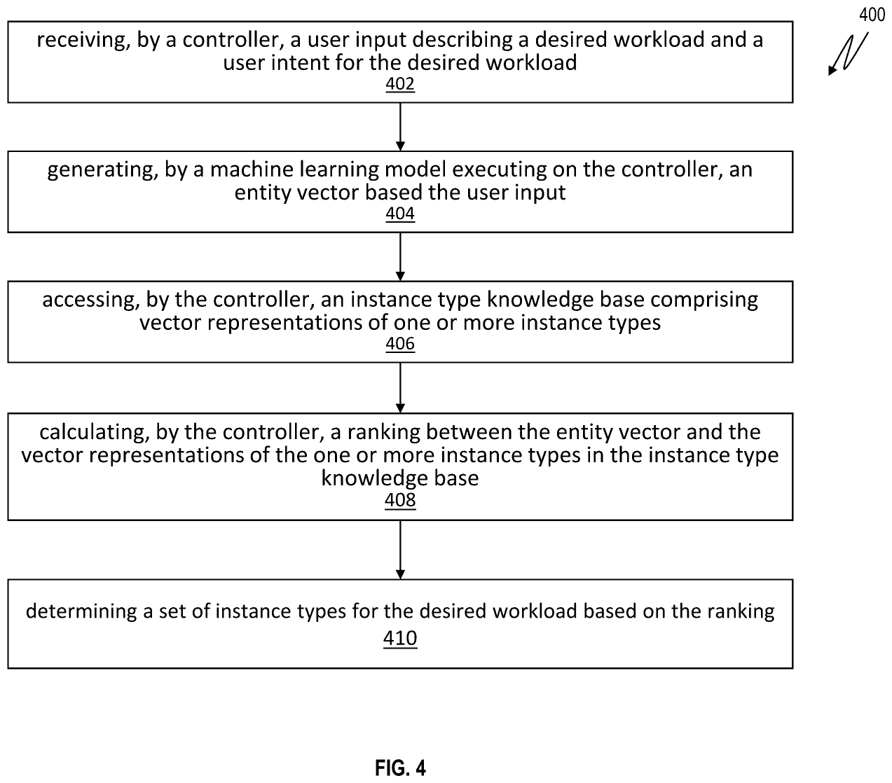

FIG. 4 illustrates a block diagram of a method for dynamically generating instance types according to one or more embodiments. The method 400 includes receiving, by a controller, a user input describing a desired workload and a user intent for the desired workload, as shown in block 402. At block 404, the method 400 includes generating, by a machine learning model executing on the controller, an entity vector based the user input. Also, at block 406, the method 400 includes accessing, by the controller, an instance type knowledge base comprising vector representations of one or more instance types. Further, the method 400 includes calculating, by the controller, a ranking between the entity vector and the vector representations of the one or more instance types in the instance type knowledge base, as shown at block 408. And at block 410, the method 400 includes determining a set of instance types for the desired workload based on the ranking.

Additional processes may also be included. It should be understood that the processes depicted in FIG. 4 represent illustrations, and that other processes may be added or existing processes may be removed, modified, or rearranged without departing from the scope and spirit of the present invention.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed:

1. A computer-implemented method for dynamically generating instance types, the method comprising:
receiving, by a controller, a user input describing a desired workload and a user intent for the desired workload;
generating, by a machine learning model executing on the controller, an entity vector based the user input;
accessing, by the controller, an instance type knowledge base comprising vector representations of one or more instance types;
calculating, by the controller, a ranking between the entity vector and the vector representations of the one or more instance types in the instance type knowledge base; and
determining a set of instance types for the desired workload based on the ranking.

2. The computer-implemented method of claim 1, further comprising:
selecting, by the controller, a first instance type from the set of instance types for the desired workload.

3. The computer-implemented method of claim 2, further comprising:
monitoring, by the controller, the desired workload running on the first instance type;
generating additional entity vectors based on the monitoring the desired workload running on the first instance type; and
re-training the machine learning model using an updated entity vector, wherein updated entity vector comprises the additional entity vector and the entity vector.

4. The computer-implemented method of claim 1, wherein the user input comprises a YAML file.

5. The computer-implemented method of claim 4, wherein the YAML file comprises a user intent.

6. The computer-implemented method of claim 5, wherein the user intent is determined based on a top-level comment in the YAML file.

7. The computer-implemented method of claim 1, wherein the machine learning model comprises a Bidirectional Encoder Representations from Transformers model.

8. A system comprising:
a memory having computer readable instructions; and
one or more processors for executing the computer readable instructions, the computer readable instructions controlling the one or more processors to perform operations comprising:
receiving a user input describing a desired workload and a user intent for the desired workload;
generating, by a machine learning model, an entity vector based the user input;
accessing an instance type knowledge base comprising vector representations of one or more instance types;
calculating a ranking between the entity vector and the vector representations of the one or more instance types in the instance type knowledge base; and
determining a set of instance types for the desired workload based on the ranking.

9. The system of claim 8, wherein the one or more processors perform further operations comprising:
selecting, by the controller, a first instance type from the set of instance types for the desired workload.

10. The system of claim 9, wherein the one or more processors perform further operations comprising:
monitoring, by the controller, the desired workload running on the first instance type;
generating additional entity vectors based on the monitoring the desired workload running on the first instance type; and
re-training the machine learning model using an updated entity vector, wherein updated entity vector comprises the additional entity vector and the entity vector.

11. The system of claim 8, wherein the user input comprises a YAML file.

12. The system of claim 11, wherein the YAML file comprises a user intent.

13. The system of claim 12, wherein the user intent is determined based on a top-level comment in the YAML file.

14. The system of claim 8, wherein the machine learning model comprises a Bidirectional Encoder Representations from Transformers model.

15. A computer program product comprising a computer readable storage medium having program instructions embodied therewith, the program instructions executable by a processor to cause the processor to perform operations comprising:
receiving a user input describing a desired workload and a user intent for the desired workload;
generating, by a machine learning model, an entity vector based the user input;
accessing an instance type knowledge base comprising vector representations of one or more instance types;
calculating a ranking between the entity vector and the vector representations of the one or more instance types in the instance type knowledge base; and
determining a set of instance types for the desired workload based on the ranking.

16. The computer program product of claim 15, further comprising:
selecting a first instance type from the set of instance types for the desired workload.

17. The computer program product of claim 16, further comprising:
monitoring the desired workload running on the first instance type;
generating additional entity vectors based on the monitoring the desired workload running on the first instance type; and
re-training the machine learning model using an updated entity vector, wherein updated entity vector comprises the additional entity vector and the entity vector.

18. The computer program product of claim 15, wherein the user input comprises a YAML file.

19. The computer program product of claim 18, wherein the YAML file comprises a user intent.

20. The computer program product of claim 19, wherein the user intent is determined based on a top-level comment in the YAML file.
